(19) United States
(12) Patent Application Publication
(10) Pub. No.: US 2007/0017577 A1
(43) Pub. Date: Jan. 25, 2007

(54) Fluid control value assembly

(75) Inventors: Takahiro Kouzu, Kariya-city (JP); Tadashi Komiyama, Chiryu-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/483,610

(22) Filed: Jul. 11, 2006

(30) Foreign Application Priority Data
Jul. 20, 2005 (JP) 2005-209584

(51) Int. Cl. F16K 49/00

(52) U.S. Cl. 137/339

(57) ABSTRACT

A fluid control valve assembly is disclosed that includes a housing. The housing defines an inlet pipe and a valve port in fluid communication with the inlet pipe, such that a fluid passes from the inlet pipe and through the valve port. The inlet pipe defines an inlet pipe axis and the valve port defines a valve port axis. The fluid control valve assembly also includes a valve movably supported within the housing. The valve includes a valve head for opening and closing the valve and a valve shaft coupled to the valve head. The valve shaft defines a valve axis that is coaxial with the valve port axis. The inlet pipe is orientated toward the valve port such that a positive, acute angle is formed between the inlet pipe axis and a plane perpendicular to the valve axis.

### CROSS REFERENCE TO RELATED APPLICATION

The following is based on and claims the benefit of priority from Japanese Patent Application No. 2005-209584, filed on Jul. 20, 2005, which is hereby incorporated by reference.

1. Field of the Invention

The present invention relates to a fluid control valve and, more particularly, relates to a fluid control valve with an inlet pipe oriented at a positive, acute angle with respect to a valve axis.

2. BACKGROUND OF THE INVENTION

Exhaust systems have proposed that include a secondary-air supplying apparatus for activating a three-way catalyst for cleaning exhausted gas. The apparatus introduces secondary air from an electric air pump to a three-way catalyst converter. Typically, the secondary-air is supplied when exhaust gas flowing from the combustion chamber the internal combustion engine has a relatively low temperature (e.g., when the engine is first started, etc.).

Representative devices are disclosed in Japanese patent applications 2002-260919A, 2002-272080A, and 2002-340216A. These devices typically include an electromagnetic secondary-air control valve assembly provided on a secondary-air duct through which the secondary air flows to the three-way catalyst converter.

Specifically, as shown in FIG. 6, the conventional electromagnetic secondary-air control valve assembly includes an electromagnetic valve 101 and a check valve 102. The electromagnetic valve 101 functions as an air-switching valve for intermittently controlling the flow of secondary air. The check valve 102 is a valve for inhibiting exhaust gas from flowing back upstream toward the electromagnetic-valve side. The electromagnetic valve 101 comprises a valve housing 104, a poppet valve 106, and an electromagnetic driving section. Inside the valve housing 104, a valve sheet 103 is formed. The poppet valve 106 is a valve for opening and closing a valve port 105 formed inside the valve sheet 103. The electromagnetic driving section is a unit for driving the poppet valve 106 in the valve-opening direction.

In addition, an inlet pipe 110 is provided on the outer-diameter side of a cylindrical portion serving as the main body of the valve housing 104. The inlet pipe 110 is oriented in the radial direction of the cylindrical portion. Inside the valve housing 104, air-introducing ducts 112, 113 and an inlet port 111 are formed. A linking passage 114 is formed downstream of the valve sheet 103.

The poppet valve 106 has a valve head 115 and a valve shaft 116 extending from the center axis of the valve head 115 in one direction (i.e., upwards in FIG. 6). The valve head 115 opens and closes the valve port 105 by being seated on and unseated from the valve sheet 103.

The check valve 102 includes an outlet case 120, a metallic plate 121, a reed valve 123, and a reed stopper 124. The outlet case 120 is joined to the downstream-side end of the valve housing 104. The metallic plate 121 is held by the outlet case 120. The reed valve 123 is a thin-film valve for opening and closing a fluid-passing opening 122 formed in the metallic plate 121. The reed stopper 124 is a unit for restricting the degree of opening of the fluid-passing opening 122. An outlet duct 127 with an outlet port 126 is provided inside the outlet case 120.

The electromagnetic driving section linearly moves the valve shaft 116 of the poppet valve 106 to open and close the valve port 105. Since the electromagnetic driving section is provided on an extension line of the valve shaft 116, the center axis of the inlet pipe 110 cannot be coaxial with the center axis of the valve port 105. Instead, the poppet valve 106 is oriented such that the center axis of the inlet pipe 110 forms a right angle with respect to the center axis of the valve shaft 116 of the poppet valve 106. As a result, the fluid flows through the inlet pipe 110 and then turns rather sharply in front of the valve port 105. In other words, the secondary air passes through the air-introducing duct 113 in a linear fashion along the straight axis of the inlet pipe 110, and then the air flows in a right angle toward the valve port 105. As a result, there is an increase in pressure loss of the secondary air as it passes through the air-introducing duct 112.

In addition, in the conventional electromagnetic secondary-air control valve assembly, the valve port 105 of the electromagnetic valve 101 is typically coaxial with the axis of the fluid-passing opening 122 of the check valve 102. When the valve head 115 of the poppet valve 106 moves away from the valve sheet 103 to open the valve port 105, the valve head 115 blocks a portion of the fluid-passing opening 122 of the check valve 102. Thus, the stream of secondary air flowing from the valve port 105 toward the fluid-passing opening 122 flows around the periphery of the valve head 115. In other words, the stream of the secondary air turns rather sharply when passing through the linking passage 114 before flowing into the fluid-passing opening 122. As a result, there is an increase in pressure loss of the secondary air as it passes through the fluid-passing opening 122.

Since the pressure loss incurred by the secondary air is relatively large, there is a decrease in the amount of secondary air flowing through the electromagnetic secondary-air control valve assembly from the electric air pump to the three-way catalyst converter. Thus, there may be an insufficient amount of air that flows to the catalyst converter.

Although the internal cross sectional area of the inlet pipe 110, the valve port 105, the linking passage 114, and/or the fluid-passing opening 122 can be increased to increase air flow, the valve assembly as a whole will likely increase in size. As a result, the valve assembly may not properly fit within the vehicle.

### SUMMARY OF THE INVENTION

A fluid control valve assembly is disclosed that includes a housing. The housing defines an inlet pipe and a valve port in fluid communication with the inlet pipe, such that a fluid passes from the inlet pipe and through the valve port. The inlet pipe defines an inlet pipe axis and the valve port defines a valve port axis. The fluid control valve assembly also includes a valve movably supported within the housing. The valve includes a valve head for opening and closing the valve and a valve shaft coupled to the valve head. The valve shaft defines a valve axis that is coaxial with the valve port axis. The inlet pipe is orientated toward the valve port such that a positive, acute angle is formed between the inlet pipe axis and a plane perpendicular to the valve axis.

### BRIEF DESCRIPTION OF THE DRAWINGS

FIG. 1 is a cross sectional view of a secondary-air control valve assembly according to a first embodiment;

FIG. 2 is a cross sectional view of the secondary-air control valve assembly according to the first embodiment;

FIG. 3 is a cross sectional view of a motor actuator for the valve assembly according to the first embodiment;

FIG. 4 is a top view of the motor actuator according to the first embodiment;

FIG. 5 is a cross sectional view of the secondary-air control valve assembly according to a second embodiment; and

FIG. 6 is a cross sectional view of a conventional secondary-air control valve assembly.

### DETAILED DESCRIPTION OF THE PREFERRED EMBODIMENTS

First Embodiment

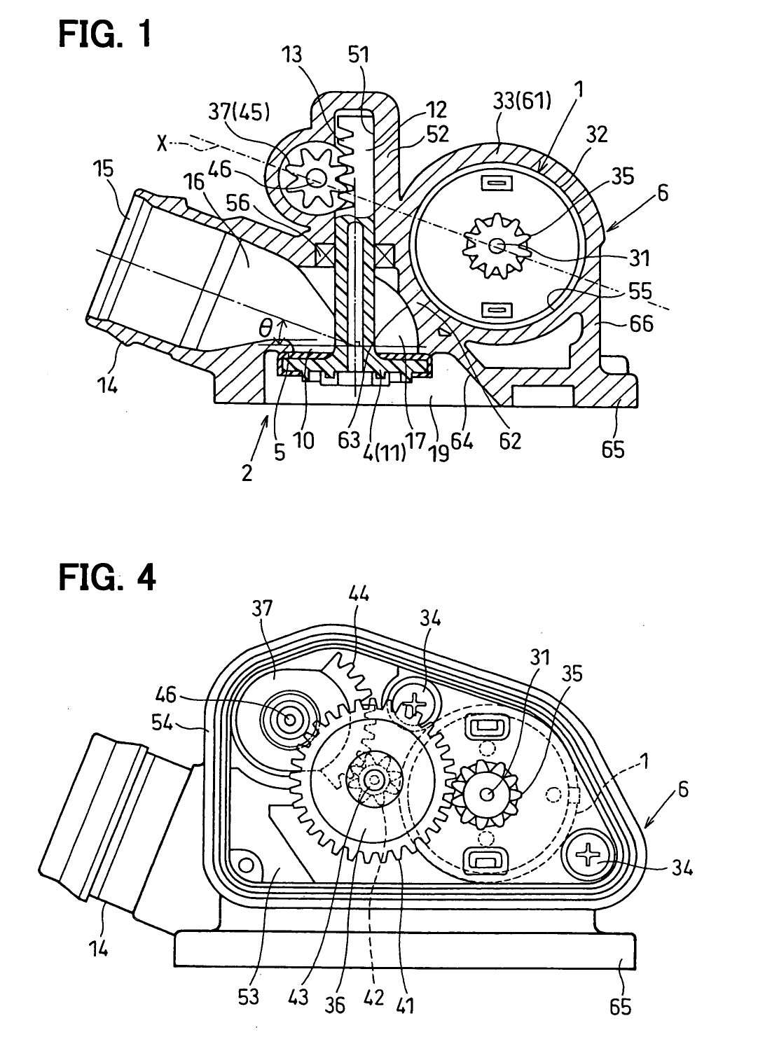

FIGS. 1 to 4 are diagrams showing a first embodiment of a secondary-air control valve assembly according to the present invention. The secondary-air control valve assembly is incorporated in a secondary-air supplying system (i.e., a secondary-air supplying apparatus) of a vehicle (e.g., a car). The secondary-air supplying system comprises an electric air pump (not shown), and the secondary-air control valve assembly is operably connected to the electric air pump through a secondary air duct. Also, the secondary-air control valve assembly is connected to an exhaust pipe of the engine through another secondary air duct. Thus, the valve assembly introduces secondary air in the secondary air duct to a three-way catalyst converter (not shown). In one embodiment, the valve assembly causes this fluid flow soon after an internal combustion engine (e.g., a gasoline engine) has been started in order to heat the three-way catalyst of the three-way catalyst converter for more effective operation. In the following description, the internal combustion engine is referred to simply as an engine.

The secondary-air control valve assembly includes an electric motor 1. The secondary-air supplying system according to this embodiment includes an engine control unit (i.e., ECU) for electronically controlling an electric motor 1, in accordance with the operating state of the engine. The ECU is a microcomputer having commonly known structure including a CPU for executing control and processing as well as a storage device (e.g., ROM and/or RAM) for storing a variety of programs and data. The ECU is a motor control unit for adjusting electric power supplied to the electric motor 1. The ECU controls rotational operation of the electric motor 1 by execution of a control program stored in the storage device. At the start of the engine (i.e., when an ignition switch is turned on (IG=ON)), the ECU detects the temperature of exhausted gas based on a signal from an exhausted-gas temperature sensor (not shown). When the detected temperature of the exhaust gas is equal to or lower than a predetermined value, electric power is supplied to the electric motor 1 to drive the ASV 2 to an opened-valve state. Electric power is also supplied to the electric air pump.

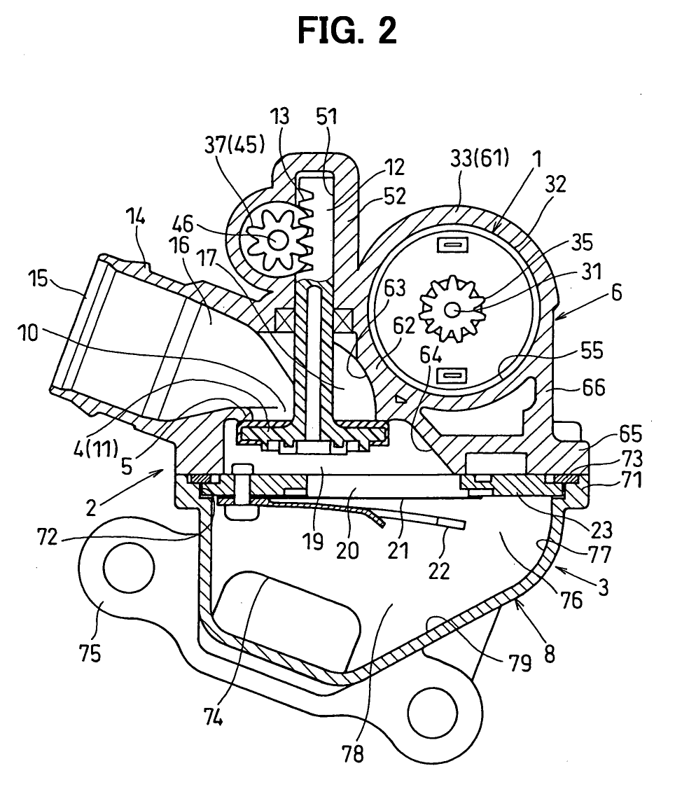

The secondary-air control valve assembly is an electric fluid control valve comprising an air-switching valve (i.e., ASV) 2 and a check valve 3. FIG. 1 shows the ASV 2 only, and FIG. 2 shows both the ASV 2 and the check valve 3 coupled together. The electric fluid control valve is also referred to as an electric valve module. The ASV 2 is also referred to as a fluid-duct opening/closing valve or an air-duct opening/closing valve. The ASV 2 is a valve for opening and closing a secondary air duct (i.e., a fluid duct) formed inside a housing. The check valve 3 is a valve for reducing the amount of fluid (e.g., exhaust gas) from flowing upstream from the exhaust pipe back toward the ASV 2.

The ASV 2 includes a housing with an inlet pipe 14 with an inlet port 15. The housing also defines a valve port 10 having a cylindrical shape. Secondary air flows from the inlet port 15, through the inlet pipe 14, and to the valve port 10 by way of fluid-introducing ducts 16 and 17.

The ASV 2 includes a poppet valve 4 that is movably mounted. The poppet valve 4 moves back and forth along a straight center axis direction. The ASV 2 also includes a valve sheet 5 (i.e., a valve seat section) on which the poppet valve 4 seats.

The poppet valve 4 comprises a valve head 11 having a flange shape and a valve shaft 12 having a cylindrical shape. In other words, the valve head 11 has a shape resembling a brim, and the outer diameter of the valve head 11 is greater than the external diameter of the valve shaft 12. The valve head 11 is provided at one axial end of the valve shaft 12. In one embodiment, the poppet valve 4 is created from a resin material as a single unit.

An elastic body (i.e., a seal rubber body) made from a material of the rubber group covers the valve head 11. In one embodiment, the elastic body is coupled to the valve head 11 by a printing/baking technique. The elastic body serves as a body for enhancing the sealing state (i.e., the air-proof state) between the valve head 11 and the valve sheet 5.

The end of the valve shaft 12 opposite to the valve head 11 (i.e., the upper end in the figures) includes a rack 13. The rack 13 includes a plurality of teeth. The rack 13 is an element of a movement-direction conversion mechanism to be described in greater detail below.

The poppet valve 4 is mounted so as to move reciprocally in an axial direction relative to the valve sheet 5 for opening and closing the valve port 10. More specifically, in this embodiment, the poppet valve 4 is formed such that the back face (i.e., valve face, downstream face, etc.) of the valve head 11 of the poppet valve 4 is seated on the bottom-end face (i.e., lower-side face, downstream face, etc.) of the valve sheet 5.

When the poppet valve 4 is in an opened-valve state, the valve head 11 is unseated (i.e., lifted) from the valve sheet 5. The valve head 11 is held (or placed) at a position to thereby allow fluid flow to a link passage 19 created between the check valve 3 and the valve sheet 5. Thus, in the opened-valve state, the poppet valve 4 moves away from the valve sheet 5 and toward the check valve 3 in the center axial direction.

The check valve 3 is provided downstream of the valve sheet 5 and valve port 10. The check valve 3 has a fluid passing opening 20 through which the secondary air flows. The check valve 3 reduces the amount of exhaust gas flowing upstream away from the three-way catalyst converter and back toward the ASV 2. In one embodiment, the check valve 3 prevents substantially all of the exhaust gas from flowing upstream back toward the ASV 2. The check valve 3 comprises a reed valve 21, a reed stopper 22 and a metallic plate 23. The reed valve 21 has a thin-film shape and moves to an opened-valve state due to pressure of secondary air blown by the electric air pump.

The reed stopper 22 is a component for restricting the degree of opening of the reed valve 21. In other words, the reed stopper 22 is a component for limiting the maximum opening of the reed valve 21. The metallic plate 23 is a plate for firmly supporting the fixed end of the reed valve 21 and the fixed end of the reed stopper 22.

The reed valve 21 is created from a thin film made of a metallic material such as a plate spring. One end of the reed valve 21 is fixed to a downstream face of the metallic plate 23. The reed valve 21 includes a movable plate having a double-tongue shape or a triple-tongue shape. The movable plate is used for opening and closing the fluid passing opening 20. More specifically, the movable plate elastically deforms (about the fixed end) to thereby move toward and away from the fluid passing opening 20. As such, the movable plate opens and closes the fluid passing opening 20.

When the reed valve 21 is put in an opened-valve state by a pressure of secondary air blown by the electric air pump, the movable plate of the reed valve 21 moves away from the downstream face of the metallic plate 23 and contacts the upstream face of the reed stopper 22.

The reed stopper 22 is manufactured as a metallic plate. One end of the reed valve 21 and the reed stopper 22 is a fixed end. In the embodiment shown, a fastener extends through the metallic plate 23 for supporting the fixed end of the reed stopper 22 and reed valve 21. On the free-end side opposite to the fixed-end side, the reed stopper 22 includes a stopper section having a double-tongue shape or a triple-tongue shape. The stopper section is used for restricting the degree of opening of the movable plate of the reed valve 21. The fixed end of the reed valve 21 is firmly attached to the downstream face of the fixed end of the reed valve 21.

The metallic plate 23 is a frame (or a valve sheet) made of aluminum alloy or another suitable material. The metallic plate 23 defines the fluid passing opening 20. In one embodiment, the metallic plate 23 includes a mesh that covers the fluid passing opening 20.

The center axis of the fluid-passing opening 20 is misaligned with the axis of the valve port 10. In other words, the axis of the fluid passing opening 20 is offset with respect to the axis of the valve port 10.

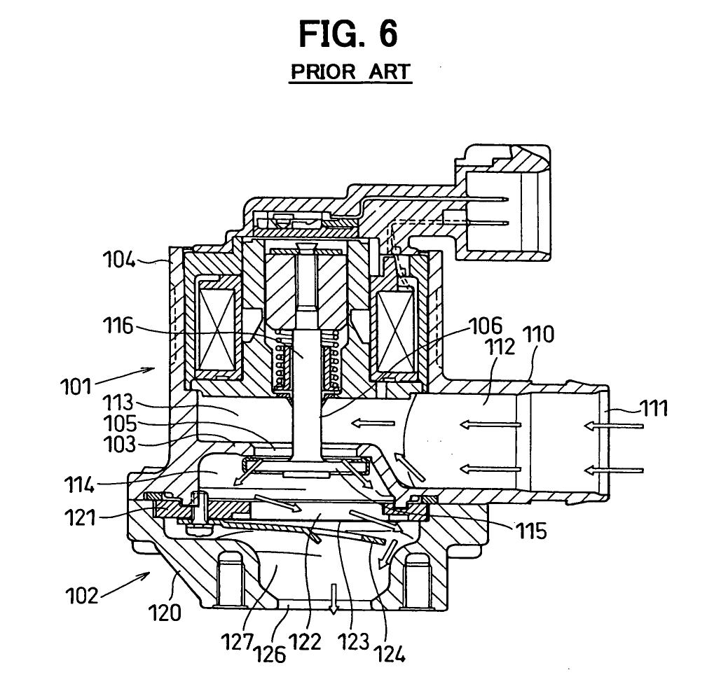

In one embodiment, a rubber seal material with a meshed shape is fixed on a passage wall face of the fluid passing opening 20. The meshed rubber seal is attached by using a printing/baking technique or the like. The frame section of the metallic plate 23 is widened more than the conventional technology (e.g., more than in the embodiment of FIG. 6).

A valve-driving apparatus (i.e., a motor actuator) drives the poppet valve 4 of the ASV 2 between the opened-valve state and the closed-valve state. The valve-driving apparatus includes the aforementioned electric motor 1 driven by electric power and a power transmission mechanism including a movement-direction conversion mechanism. The electric motor 1 is a brushless direct-current (DC) motor comprising a rotor joined to an output shaft (or a motor shaft) 31 to form,a single assembly and a stator interfacing with the external-circumference side of the rotor. The rotor includes a rotor core having a permanent magnet. The stator comprises a stator core wound by an armature coil and a yoke 32 having a cylindrical shape. When the ECU allows a current to flow to the electric motor 1, the motor shaft 31 rotates in either a forward direction (i.e., the valve-opening direction) or in a reverse direction (i.e., the valve-closing direction). The electric motor 1 is fixed to the opening peripheral edge of a motor insertion section of a motor case 33 by using a tightening screw 34. It is to be noted that, in place of the brushless DC motor 1, a brush DC motor or an AC (alternating current) motor such as a three-phase induction motor can also be used.

The power transmission mechanism is a mechanism for transmitting a rotating power generated by the electric motor 1 to the valve shaft 12 of the poppet valve 4. The power transmission mechanism functions as a geared deceleration mechanism to reduce the rotational speed (or the motor speed) of the motor shaft 31 of the electric motor 1 at a predetermined deceleration ratio. The geared deceleration mechanism includes the pinion gear 35 (i.e., a motor-side gear, a first rotation driving body, etc.), the intermediate deceleration gear 36 (i.e., a second rotation driving body), the valve-side gear 37 (i.e., a last gear in the deceleration mechanism, a third rotation driving body, etc.) and the rack 13 mounted on the valve shaft 12 of the poppet valve 4. The pinion gear 35 has a cylindrical shape and is fixed on the outer circumference of the motor shaft 31 of the electric motor 1. The intermediate deceleration gear 36 is engaged with the pinion gear 35 and propagates a motor torque from the pinion gear 35 to the valve-side gear 37. The valve-side gear 37 is engaged with the intermediate deceleration gear 36 and receives a motor torque propagated from the intermediate deceleration gear 36.

The pinion gear 35 is provided on the same axis as the motor shaft 31 of the electric motor 1. The pinion gear 35 has a gear diameter that is smaller than the external diameter (i.e., the motor diameter) of the maximum external diameter section (i.e., the yoke 32) of the electric motor 1. The gear diameter of the pinion gear 35 is also smaller than the external diameter (i.e., the gear diameter) of the maximum external diameter section (i.e., the large diameter gear 41) of the intermediate deceleration gear 36.

The intermediate deceleration gear 36 includes the large diameter gear 41, which is engaged with the pinion gear 35, and a small diameter gear 42, which is engaged with the valve-side gear 37. The intermediate deceleration gear 36 is engaged with the outer circumference of a support shaft 43 and is oriented such that the intermediate deceleration gear 36 is capable of rotating with a high degree of freedom. The support shaft 43 is provided approximately parallel to the motor shaft 31 of the electric motor 1. The large diameter gear 41 of the intermediate deceleration gear 36 has a gear diameter that is smaller than the motor diameter of the electric motor 1 but that is greater than the external diameter (i.e., the gear diameter) of the maximum diameter portion (i.e., the gear section 44) of the valve-side gear 37.

The valve-side gear 37 is oriented in a direction perpendicular to center axis of the valve shaft 12 of the poppet valve 4. The valve-side gear 37 includes the gear section 44, which is engaged with the large diameter gear 41 of the intermediate deceleration gear 36. The valve-side gear 37 also includes a cylindrical pinion gear 45 engaged with the rack 13. The valve-side gear 37 is engaged with the outer circumference of a support shaft 46 in such an orientation that the valve-side gear 37 is capable of rotating with a high degree of freedom. The support shaft 46 is approximately parallel to the motor shaft 31 of the electric motor 1 and the support shaft 43. The gear section 44 of the valve-side gear 37 has a gear diameter smaller than the motor diameter of the electric motor 1 and the diameter of the large diameter gear 41 of the intermediate deceleration gear 36. However, the gear section 44 has a gear diameter greater than the gear diameter of the pinion gear 45 of the valve-side gear 37.

The motor shaft 31 of the electric motor 1 functions as a gear shaft centered at the rotational center of the pinion gear 35. The support shaft 43 functions as a gear shaft centered at the rotational center of the intermediate deceleration gear 36. By the same token, the support shaft 46 functions as a gear shaft centered at the rotational center of the valve-side gear 37. Both ends of each of the support shafts 43, 46 are inserted (e.g., by press fit) into an aperture created on the housing.

The power transmission mechanism functions as a movement-direction conversion mechanism (i.e., a rack and a pinion) for rotating the pinion gear 45 to thereby drive the rack 13 and ultimately move the poppet valve 4 axially to open and close the poppet valve 4. Thus, the power transmission mechanism converts the rotational movement of the motor shaft 31 of the electric motor 1 into a back-and-forth linear movement of the poppet valve 4.

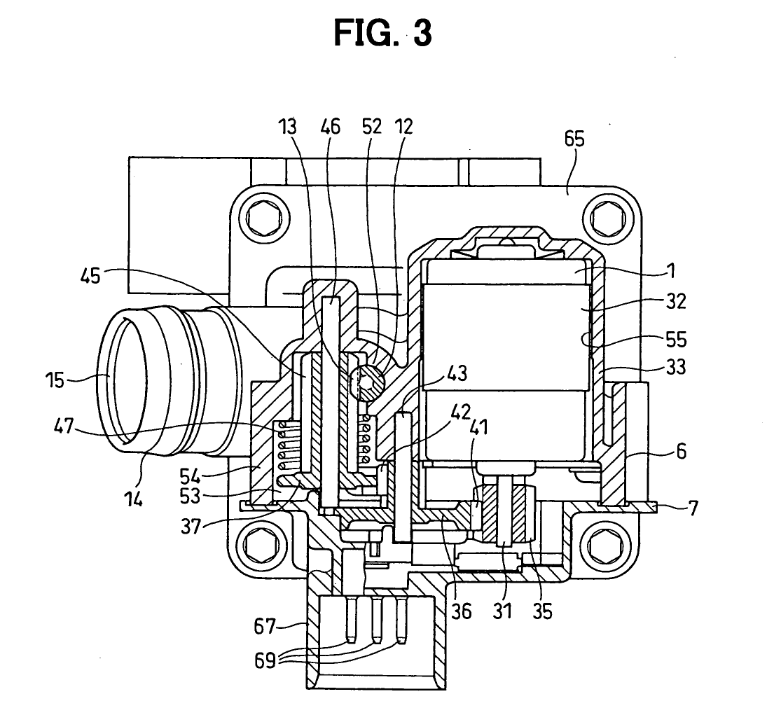

A coil spring 47 is also included (see FIG. 3) and is mounted coaxially with the support shaft 46. When the valve-side gear 37 is rotated in a valve-opening direction, the coil spring 47 biases the poppet valve 4 toward the valve-closing direction. In other words, in the embodiment shown, the coil spring 47 generates an elastic return force to rotate the valve-side gear 37 in a direction opposite to the valve-opening direction.

The ASV 2 and the check valve 3 are included in the aforementioned housing along with the electric motor 1. The housing comprises three cases, i. e., a valve case 6, a case cover 7 and an outlet case 8. The valve case 6, the case cover 7 and the outlet case 8 are joined to each other by using tightening screws, clamps, or the like. The valve case 6 is made of a metallic material such as a die cast aluminum having good thermal conductivity. The valve case 6 is integrally formed to be a single assembly including several components. The components include the valve sheet 5 and the inlet pipe 14. In another embodiment, the valve sheet 5 is separate but joined to the valve case 6.

The inlet pipe 14 has a straight-pipe shape and is fluidly connected to the electric air pump through the secondary air duct. The aforementioned fluid-introducing duct 16 is included at one end of the inlet pipe 14. The fluid-introducing duct 16 is inclined toward the center axis of the valve port 10. Also, the inlet pipe 14 is oriented in such a direction that the center axis of the inlet pipe 14 is inclined toward the valve port 10.

An intersection angle θ formed by the center axis of the inlet pipe 14 in conjunction with a plane that is perpendicular to the center axis of the valve shaft 12 of the poppet valve 4 is a positive, acute angle smaller than 90 degrees (see FIG. 1). The intersection angle θ can be any acute angle in the range between 0 degrees and 90 degrees. In one embodiment, the intersection angle θ is between 20 degrees to 80 degrees. Furthermore, in one embodiment, the intersection angle θ is between 30 degrees to 60 degrees.

Inside the valve case 6, the aforementioned fluid introducing duct 17 links the fluid introducing duct 16 to the valve port 10. At the exit of the valve case 6, the aforementioned link passage 19 serves as a link to the fluid passing opening 20 of the check valve 3. The link passage 19 is a secondary air duct extending substantially linearly. The link passage 19 is inclined toward the center axis of the fluid passing opening 20 of the check valve 3, being oriented in a direction from the valve port 10 to the fluid passing opening 20.

On the valve case 6, components are created to form a single assembly with the valve case 6. The components include a cylindrical valve guide 52 that defines an axial-direction hole 51, a cylindrical gear box 54 that defines a gear chamber 53, and the aforementioned motor case 33 that defines a motor accommodation hollow 55.

The valve shaft 12 of the poppet valve 4 is movably provided inside the axial-direction hole 51. A seal rubber 56 with a circular circumference is provided for avoiding leakages of secondary air from the fluid-introducing duct 17. The seal rubber 56 is mounted between the outer circumference of the valve shaft 12 and the inner surface of the valve guide 52. The gear box 54 and the case cover 7 cooperate to define an actuator case. Inside the gear chamber 53, the gear box 54 accommodates gears of the geared deceleration mechanism of the power transmission mechanism such that the gears are each capable of rotating with a high degree of freedom. The accommodated gears are the pinion gear 35, the intermediate deceleration gear 36 and the valve-side gear 37.

The gears 35, 36, 37 of the geared deceleration mechanism of the power transmission mechanism are provided inside the motor case 33 and inside the gear box 54. Collectively, the gears 35, 36, 37 are oriented approximately parallel to the center axis of the inlet pipe 14. In other words, a line (marked X in FIG. 1) extending normally to and approximately through the axes of the gears 35, 36, 37 is approximately parallel to the center axis of the inlet pipe 14. Thus, in the valve-driving apparatus, the gear section 44 of the valve-side gear 37, the large diameter gear 41 of the intermediate deceleration gear 36 and the pinion gear 35 are sequentially arranged in a direction from the inlet-port side of the inlet pipe 14 to the valve-port side.

On the bottom wall of the gear box 54, a motor insertion entrance of the motor case 33 is provided as an opening. The motor case 33 of the valve case 6 accommodates the electric motor 1 inside the motor accommodation hollow 55. The outer circumferential face of the yoke 32 of the electric motor 1 is firmly fixed on the inner circumferential face of the motor case 33.

A first heat transfer section 61 and a second heat transfer section 62 are provided on the cylindrical face of the motor case 33. The first heat transfer section 61 defines a portion of the cylindrical face over the outer circumference of the yoke 32 of the electric motor 1. The first heat transfer section 61 is exposed in such an orientation that the first heat transfer section 61 transfers heat to the open air flowing outside the valve case 6. In one embodiment, fins having a plate shape are provided on the first heat transfer section 61 in order to increase the heat radiating area of the first heat transfer section 61.

On the other hand, the second heat transfer section 62 forms a portion of a cylindrical face over the outer circumference of the yoke 32 of the electric motor 1. More specifically, the second heat transfer section 62 is bent smoothly from the outer circumference of the yoke 32 of the electric motor 1 toward the valve port 10 or the vicinity of a fluid-passing opening. The second heat transfer section 62 transfers heat dissipated by the electric motor 1 to secondary air flowing through the fluid introducing duct 17 of the valve case 6. In one embodiment, in order to increase the heat radiating area of the second heat transfer section 62, fins each having a plate shape are formed on the second heat transfer section 62. Preferably, the fins are added so as not to drastically increase the fluid flow resistance of the fluid-introducing duct 17.

On the inner wall face on the motor side (that is, on a side opposite to the inlet-pipe side) of the middle portion of the valve case 6 according to this embodiment, a curved face 63 is formed against the direction of secondary air flowing from the exit of the inlet port 15 and the exit of the fluid introducing duct 16. The curved face 63 is curved in order to smoothly introduce the secondary air flowing from the exit of the fluid introducing duct 16 into the inside of the fluid introducing duct 17 to the valve port 10 without dramatically increasing the pressure loss of the secondary air. A portion of the curved face 63 forms the heat radiating face of the second heat transfer section 62. In addition, the curved face 63 is bent smoothly to form an arc shape (e.g., a hemispherical shape).

On the inner wall face on the motor side (i.e., on a side opposite to the inlet-pipe side) of the exit of the valve case 6, an inclined face 64 extends in the direction of fluid flow. The inclined face 64 (i.e., taper face) is inclined with respect to the center axis of the fluid passing opening 20 by a predetermined angle of inclination. More specifically, the inclined face 64 is inclined with respect to the center axis of the fluid passing opening 20 and to the center axis of the valve port 10.

A reinforcement rib 66 for reinforcing the motor case 33 is provided between the first heat transfer section 61 and a join section 65 of the valve case 6. The join section 65 is a section for joining the first heat transfer section 61 to the outlet case 8.

The case cover 7 is made of a resin material (e.g., electrically insulating resin). The case cover 7 is formed to allow a male connector to be connected mechanically to a female connector provided on an edge side of a wire harness on the vehicle side (or the ECU side) to form a single assembly. By plugging the female connector into a connector shell 67 of the male connector, the male connector electrically connects a motor driving circuit embedded in the ECU to a terminal 69. The wire harness on the vehicle side is a bundle of electrically conductive wires in an insulating protection tube surrounding the outer circumference of the bundle. The electrically conductive wires are each electrically connected to a female-type terminal provided on the female connector.

The outlet case 8 is made of a metallic material such as die cast aluminum. On the opening edge of the entrance of the outlet case 8, a junction section 71 (i.e., a junction section of the outlet case 8) is created so as to provide fluid communication with the junction section 65 of the valve case 6.

On the inner surface of the junction section 71 of the outlet case 8, an engagement section 72 is formed with which the external circumferential edge of the metallic plate 23 of the check valve 3 is engaged. Between the junction section 65 of the valve case 6 and the junction section 71 of the outlet case 8, is a seal rubber 73. The seal rubber 73 has a shape with an angular circumference. The seal rubber 73 reduces leakage of secondary air flowing from between the exit of the valve case 6 and the outlet case 8.

The downstream end of the outlet case 8 includes an opening that functions as an air outlet port 74. In other words, air exits the housing through the outlet port 74. The center axis of the outlet port 74 is placed on a side opposite to the free-end side of the reed valve 21. As such, the center axis of the outlet port 74 is offset with respect to the axis of the check valve 3. The center axis of the outlet port 74 is inclined towards the fixed end of the reed valve 21. As such, the axis of the outlet port 74 is inclined at an angle with respect to the center axis of the valve port 10 of the ASV 2. On the opening peripheral edge of the outlet port 74, an installation stay 75 is integrally attached and protrudes to the outside. Fasteners (e.g., bolts and nuts) can be used to fix the installation stay 75 to external components of the vehicle engine. As an alternative, the installation stay 75 can be tightened directly to the merging portion of the exhaust pipe of the engine.

On the inner wall face on the motor side (or a side opposite to the inlet-pipe side) of the entrance of the outlet case 8 according to the embodiment, a space 76 is provided. The space 76 is located between the inner wall face and the free-end side of the reed valve 21. In addition, on the same inner wall face on the motor side of the entrance of the outlet case 8, a duct wall face is located that faces the flow of secondary air. The duct wall face of the outlet case 8 is used as a curved face 77 having a radius of curvature in order to smoothly introduce the secondary air flowing from the fluid passing opening 20 into the inside of the space 76 to the outlet port 74 without drastically increasing the pressure loss of the secondary air. In addition, the curved face 77 is bent smoothly to form an arc shape (e.g., a hemispherical shape) from the fluid passing opening 20 of the check valve 3 toward the outlet port 74.

In order to further reduce the pressure loss, the space 76 created between the curved face 77 and the free-end side of the reed valve 21 has a relatively large volume. Thus, secondary air flowing from the fluid passing opening 20 of the check valve 3 to the inside of the space 76 over the surface of the reed valve 21 can flow (more) smoothly around the reed valve 21 without stagnation. To increase the volume of the space 76, the curved face 77 (i.e., the duct wall face) of the outlet case 8 is spaced away from the free-end side of the reed valve 21.

In this embodiment, the position of the junction section 71 of the outlet case 8 is shifted to the right side in comparison with the conventional technology explained by referring to FIG. 6. Thus, since the curved face 77 (the duct wall face) of the outlet case 8 is spaced and slanted away from the free-end side of the reed valve 21, it is possible to provide a chamber with a relatively large volume in comparison with the conventional technology explained by referring to FIG. 6. In addition, the curved face 77 can have a constant radius or a varying radius.

Inside the outlet case 8, a fluid outputting duct is included that fluidly connects the exit space 76 to the outlet port 74. The fluid outputting duct has a cross-sectional area decreasing gradually in a direction from the exit of the space 76 to the outlet port 74. On the inner wall face on the motor side (i.e., a side opposite to the inlet-pipe side) of the middle portion of the outlet case 8, a duct wall face extends along the direction of fluid flow from the exit of the space 76 to the outlet port 74. This duct wall face is an inclined face 79 (i.e., a taper face). The inclined face 79 is inclined with respect to the center axis of the fluid passing opening 20 of the check valve 3 by a predetermined angle of inclination.

Operations of the First Embodiment Referring to FIGS. 1 to 4, the following description explains operations of the secondary-air supplying system according to this embodiment. That is to say, the following description explains the flow of secondary air when the secondary-air control valve assembly is in an opened-valve state.

A vehicle (e.g., a car) is provided with an exhaust-gas cleaning apparatus such as a three-way catalyst converter for applying chemical reactions to three elements. The exhaust gas includes components considered harmful. The catalyst converter causes chemical reaction to converts the harmful elements (e.g., carbon monoxide (CO), hydrocarbon (HC), and nitrogen oxide (NOx)) into harmless elements. In particular, by oxidation, the hydrocarbon (HC) is converted into harmless water (H₂O). When the mixing ratio of air to fuel in a combustion process of the engine is not equal to the stoichiometric air-fuel ratio, however, the three-way catalyst of the three-way catalyst converter is unlikely to properly carry out the chemical reactions. It is thus preferable to sustain the desired stoichiometric air-fuel ratio of 14.7:1, for instance. In addition, the three-way catalyst does not work well when the temperature of exhausted gas is low, for instance, soon after the engine is started.

In order to solve the above problem, the electric air pump is operated to generate secondary airflow through the secondary air duct. Secondary air is generated by the electric air pump and flows to the three-way catalyst converter via the secondary air duct, the secondary-air control valve assembly, and the exhaust pipe of the engine to heat and activate the three-way catalyst.

The temperature of the exhaust gas is detected by an exhaust-gas temperature sensor to detect whether the exhaust gas is lower than a predetermined value. If a low temperature value is detected, the ECU supplies electric power (or a motor driving electric current) to the electric motor 1 in order to rotate the motor shaft 31 by a predetermined rotation angle required for opening the poppet valve 4. In other words, a motor torque generated by the electric motor 1 drives the poppet valve 4 to an opened-valve state through the power transmission mechanism. As described above, the power transmission mechanism includes a geared deceleration mechanism and a movement-direction conversion mechanism (i.e., a rack-and-pinion mechanism).

More specifically, the motor shaft 31 in the electric motor 1 rotates by a predetermined angle of rotation, rotating the pinion gear 35 fixed on the motor shaft 31 of the electric motor 1 around the center axis of the motor shaft 31 by a predetermined angle of rotation. Thus, the motor torque is propagated to the large diameter gear 41 of the intermediate deceleration gear 36 engaged with the pinion gear 35.

With the rotation of the large diameter gear 41, the small diameter gear 42 of the intermediate deceleration gear 36 rotates around the center axis of the support shaft 43 by a predetermined angle of rotation, propagating the motor torque to the gear section 44 of the valve-side gear 37. A torsion elastic force is generated (or accumulated) in the coil spring 47 in a direction of inversely rotating the valve-side gear 37 to its original position. Then, with the rotation of the gear section 44, the pinion gear 45 rotates by a predetermined angle of rotation, and the rack 13 moves linearly along the axis of the valve shaft 12 by distance corresponding to the rotation angle of the pinion gear 45. As such, the valve head 11 is unseated from the valve sheet 5, and the valve port 10 is opened.

Thus, secondary air discharged from the discharging mouth of the electric air pump enters the inside of the inlet pipe 14 in the secondary-air control valve assembly from the inlet port 15 by way of the secondary air duct. The secondary air entering the inside of the inlet pipe 14 further flows into the valve port 10 from the inlet port 15 by way of the fluid-introducing ducts 16,17. Then, the secondary air passing through the valve port 10 further passes through a space between the outer circumferential edge of the valve head 11 of the poppet valve 4 and the duct wall face of the link passage 19, and flows into the fluid passing opening 20 of the check valve 3.

Subsequently, the pressure applied by the secondary air flowing into the fluid passing opening 20 causes the free-end side of the reed valve 21 to move toward and contact the reed stopper 22. In this state, the fluid passing opening 20 of the check valve 3 is opened, and the fluid passing opening 20 is in fluid communication with the space 76. Thus, the secondary air passing through the fluid passing opening 20 flows into the space 76.

Then, due to the fact that the curved face 77 of the outlet case 8 has a bent shape, the secondary air flowing into the entrance of the space 76 changes its flowing direction and flows in an opposite direction and downward toward the outlet port 74. More specifically, the secondary air flows around the free-end side of the reed valve 21 along the curved face 77 of the outlet case 8, flows along the inclined face 79 of the outlet case 8, and enters the outlet port 74 from the exit of the space 76 by way of the fluid outputting duct 78. Then, the secondary air flows out from the outlet port 74 and enters the three-way catalyst converter by way of a pipe provided on the upstream side of the three-way catalyst converter.

Thus, even when the temperature of exhausted gas is low (e.g., soon after the engine is started), secondary air is supplied to the three-way catalyst converter. As a result, oxygen (O₂) raises the temperature of the three-way catalyst and activates the three-way catalyst. In particular, since an effect of oxidation changes hydrocarbon (HC) in the exhaust gas to harmless water (H₂O), the amount of hydrocarbon exhausted to the atmosphere is reduced.

Effects of the First Embodiment

In the secondary-air control valve assembly according to the first embodiment, the center axis of the inlet pipe 14 is inclined toward the valve port 10. Specifically, the center axis of the inlet pipe 14 forms a positive, acute intersection angle 0 relative to a plane that is perpendicular to the center axis of the valve shaft 12 of the poppet valve 4. Thus, secondary air flowing from the inlet port 15 to the inside of the inlet pipe 14 (or flowing to the fluid introducing duct 16) flows substantially linearly along the center axis of the inlet pipe 14 and turns smoothly along an arc line inside the fluid introducing duct 17 through the valve port 10. As a result, pressure loss in the secondary air is less likely to occur or is likely to be reduced as compared to the conventional valve assemblies embodied in FIG. 6. Thus, the amount of secondary air required for activating the three-way catalyst converter can be ensured. Furthermore, the pressure loss is reduced without substantially increasing the size of the valve assembly. Thus, the valve assembly is more likely to meet size constraints of the vehicle.

In addition, the valve-driving apparatus for actuating the poppet valve 4 is oriented such that the gears of the deceleration mechanism are inclined approximately parallel to the direction of the center axis of the inlet pipe 14. In other words, a line (marked X in FIG. 1) extending normally to and approximately through the axes of the gears 35, 36, 37 and the respective gear shafts 31, 43, 46 is approximately parallel to the center axis of the inlet pipe 14. Also, in the valve-driving apparatus, the gear section 44 of the valve-side gear 37, the large diameter gear 41 of the intermediate deceleration gear 36 and the pinion gear 35 are sequentially arranged in a direction that corresponds to the axis of the inlet pipe 14 moving toward the valve port 10. In other words, the gear section 44 is arranged upstream of the pinion gear 35 with respect to flow through the inlet pipe 14, and the intermediate deceleration gear 36 is arranged therebetween. The diameter of the maximum diameter portion of the valve-side gear 37 (i.e., the gear section 44) is smaller than the diameter of the maximum diameter portion of the intermediate deceleration gear 36 (i.e. the large diameter gear 41), and the diameter of the maximum diameter portion (i.e., the large diameter gear 41) is smaller than the motor diameter of the maximum diameter portion (i.e., the yoke 32) of the electric motor 1. In addition, since the center axis of the inlet pipe 14 is inclined toward the valve port 10 as described above, the valve-driving apparatus can be installed efficiently in a relatively compact space (i.e., the gear box 54 and the motor case 33). Thus, the physical size of the entire configuration (or the secondary-air control valve assembly) can be decreased and a space for mounting the secondary-air control valve assembly in the vehicle can be ensured.

In addition, the electric motor 1 is incorporated inside the motor accommodation hollow 55 of the motor case 33 of the valve case 6 in such an orientation that the outer circumferential face of the yoke 32 is firmly attached to the inner circumferential face of the motor case 33. The first heat transfer section 61 is provided on the cylindrical face of the motor case 33 of the valve case 6 and is exposed to the open air outside of the valve case 6 to transfer heat thereto. In addition, the second heat transfer section 62 is provided in such an orientation that the second heat transfer section 62 is capable of radiating heat to the inside of the valve case 6. In particular, the heat radiating face of the second heat transfer section 62 on the duct wall face (or the curved face 63) faces the flow of secondary air flowing from the exit of the fluid introducing duct 16 of the inlet pipe 14 to the inside of the fluid introducing duct 17. By placing the curved face 63 on a side opposite to the inlet-pipe side with respect to the center axis of the valve shaft 12, secondary air flowing from the inlet port 15 to the inside of the fluid introducing duct 17 via the fluid introducing duct 16 contacts the curved face 63, which serves as the heat transfer face of the second heat transfer section 62. Thus, the second heat transfer section 62 is capable of transferring heat from the electric motor 1 to the secondary air flowing through the inside of the fluid introducing duct 17 so that the electric motor 1 can be cooled efficiently.

In addition, the check valve 3 is provided in the secondary-air control valve assembly, downstream of the valve port 10. The check valve 3 includes the reed valve 21, the reed stopper 22 and the metallic plate 23. The fluid passing opening 20 is formed in the metallic plate 23, allowing secondary air passing through the valve port 10 to flow pass the reed valve 21. The center axis of the fluid passing opening 20 of the check valve 3 is provided to one side of the axis of the valve port 10 such that these axes are offset (i.e., eccentric). The center axis of the fluid passing opening 20 is offset on a side of the valve port 10 opposite the inlet pipe 14. Thus, the secondary air passing through the valve port 10 flows along the duct wall face (i.e., the inclined face 64) of the valve case 6. That is to say, even if the valve head 11 is fully extended and partially blocks the fluid passing opening 20, the secondary air can flow through a space between the periphery of the valve head 11 and the duct wall face (i.e., the inclined face 64) of the valve case 6 and smoothly flow through the fluid passing opening 20. Thus, the pressure loss incurred by the secondary air flowing from the valve port 10 to the fluid passing opening 20 decreases, allowing the physical size of the entire configuration (or the secondary-air control valve assembly) to be further reduced.

In addition, the free-end side of the reed valve 21 and the free-end side of the reed stopper 22 are provided on a side of the axis of the valve port 10 opposite the inlet pipe 14. Thus, secondary air flows through the fluid passing opening 20 of the check valve 3 smoothly around the free-end side of the reed valve 21 and the reed stopper 22. Thus, there is less pressure loss incurred by secondary air flowing from the fluid passing opening 20 past the reed valve 21 and the reed stopper 22, thereby allowing the physical size of the secondary-air control valve assembly to be further reduced.

In addition, the outlet port 74 is provided on a side of the axis of the fluid passing opening 20 opposite the free-end side of the reed valve 21 and the reed stopper 22. As such, the outlet port 74 is offset with respect to the axis of the fluid passing opening 20. Thus, even when exhaust gas flows upstream through the outlet port 74 toward the check valve 3, the reed valve 21 is forced to seal and close the fluid passing opening 20. As a result, exhaust gas is unlikely to flow upstream past the fluid passing opening 20.

Moreover, on the inner wall face on the motor side (i.e., on a side opposite to the inlet pipe 14) of the entrance of the outlet case 8, the space 76 is created between the inner wall face and the free-end side of the reed valve 21. On the same inner wall face on the motor side of the entrance of the outlet case 8, a duct wall face (i.e., the curved face 77) is provided and faces the direction of flow of air passing over the surface of the reed valve 21. Thus, secondary air that flows over the surface of the reed valve 21 from the fluid passing opening 20 of the ASV 2 to the inside of the space 76 smoothly flows around the reed valve 21 and changes direction along the duct wall face (i.e., the curved face 77). As a result, the secondary air smoothly flows from the space 76 to the outlet port 74 by way of the fluid-outputting duct 78 without stagnation and, hence, without increasing the pressure loss incurred by the secondary air. Accordingly, the pressure loss incurred by the secondary air flowing from the fluid passing opening 20 of the check valve 3 to the outlet port 74 decreases, allowing the physical size of the secondary-air control valve assembly to be further reduced.

Second Embodiment

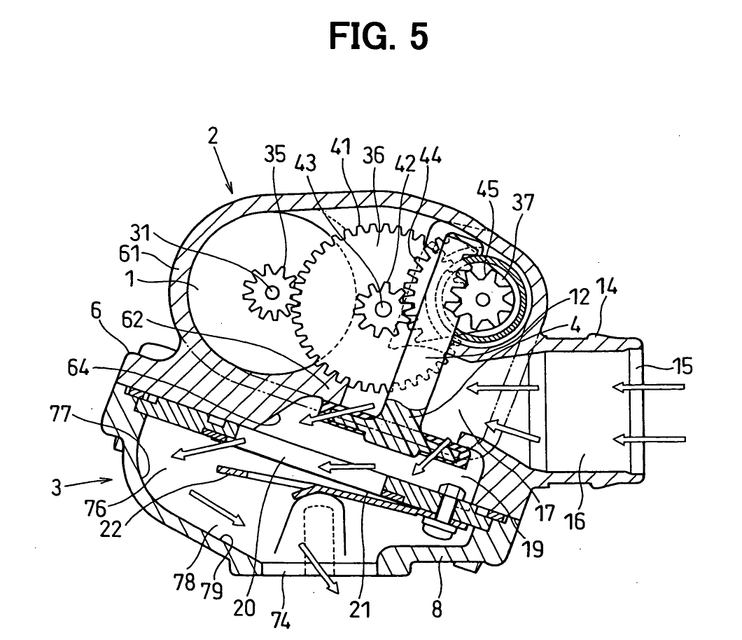

FIG. 5 is a diagram showing a secondary-air control valve assembly according to a second embodiment of the present invention. In the secondary-air control valve assembly, the inlet pipe 14 and the ASV 2 are inclined toward the center axis of the outlet port 74 by a predetermined angle of inclination for smooth flow of secondary air inside the housing. Also, the center axis of the inlet pipe 14 is inclined toward the valve port 10 such that an intersection angle θ formed by the center axis of the inlet pipe 14 and a plane that is perpendicular to the center axis of the valve shaft 12 is a positive, acute angle. Arrows shown in FIG. 5 indicate the flow direction of secondary air inside the housing where the poppet valve 4 and the reed valve 21 are in an opened-valve state.

Modified Versions

In the embodiments described above, the fluid control valve assembly of the present invention is used as a secondary-air control valve assembly in a secondary-air supplying system of a vehicle such as a car. However, it is not necessary to limit the scope of the present invention to such a secondary-air control valve assembly. For example, the fluid control valve provided by the present invention can also be used as an intake air control valve (e.g., a swirl current control valve or a tumble current control valve) or an intake air quantity control valve (e.g., a throttle valve or an idle rotation speed control valve). In addition, the fluid control valve assembly of the present invention can also be used as an exhaust-gas reflux quantity control valve (or an EGR control valve). In either case, it is not necessary to provide a check valve. On the top of that, the fluid control valve assembly provided by the present invention can also be used as a fluid-duct opening/closing valve, a fluid-duct blocking valve, a fluid quantity control valve and a fluid pressure control valve. It is to be noted that the fluid cited in the embodiments can be not only gas such as air (which can be secondary air or the open air) or evaporated fluid, but also gas such as gas-phase refrigerant, liquid such as water, fuel, oil or liquid-phase refrigerant or fluid in a two-phase state, i.e., a state of the gas and liquid phases.

In addition, as a valve-driving apparatus for driving the poppet valve 4 to an opened-valve state (or a closed-valve state), the embodiments employ a motor actuator, which includes a power transmission mechanism and uses the electric motor 1 as a power source. However, it is also possible to employ an electromagnetic actuator for driving the poppet valve 4 to an opened-valve state (or a closed-valve state) through use of an absorption electromagnetic force of a solenoid coil. In this case, the ASV 2 functions as an electromagnetic air control valve (such as an electromagnetic valve, an electromagnetic fluid quantity control valve or an electromagnetic fluid pressure control valve). In addition, as the valves, the embodiments may employ a rotary valve, a butterfly valve, a shutter-state valve or a ball valve. For each of the valves, the valve body and the valve shaft can be manufactured separately and, after the manufacturing process, the valve body and the valve shaft are joined to each other so as to allow the valve body and the valve shaft to work as a single assembly.

In the embodiments, the fixed end of the reed valve 21, the fixed end of the reed stopper 22 and the support section of the metallic plate 23 are firmly held by using rivets or the like. However, the fixed end of the reed valve 21, the fixed end of the reed stopper 22 and the support section of the metallic plate 23 can also be firmly held by using tightening screws or by using tightening screws as well as tightening bolts.

Furthermore, in one embodiment, the check valve 3 is not provided. In addition, the valve case 6 and the outlet case 8 may be formed as a single assembly of a housing. The check valve 3 may also be provided at the exit of the valve case 6. An outlet pipe having a tube shape may be provided at the exit of the outlet case 8.

While only the selected embodiments have been chosen to illustrate the present invention, it will be apparent to those skilled in the art that various changes and modifications can be made therein without departing from the scope of the invention as defined in the appended claims. Furthermore, the foregoing description of the embodiments according to the present invention is provided for illustration only, and not for the purpose of limiting the invention as defined by the appended claims and their equivalents.

What is claimed is:

1. A fluid control valve assembly comprising:
a housing defining an inlet pipe and a valve port in fluid communication with the inlet pipe, such that a fluid passes from the inlet pipe and through the valve port, wherein the inlet pipe defines an inlet pipe axis and the valve port defines a valve port axis; and
a valve movably supported within the housing, the valve including a valve head for opening and closing the valve and a valve shaft coupled to the valve head, the valve shaft defining a valve axis that is coaxial with the valve port axis;
wherein the inlet pipe is orientated toward the valve port such that a positive, acute angle is formed between the inlet pipe axis and a plane perpendicular to the valve axis.

2. A fluid control valve assembly according to claim 1, further comprising a valve-driving apparatus, which has a power transmission mechanism including a motor driven by electric power and a movement-direction conversion mechanism for converting a rotational movement of the motor into a linear movement of the valve.

3. A fluid control valve assembly according to claim 2 wherein:
the power transmission mechanism has a motor-side gear provided on the same axis as the motor, an intermediate deceleration gear engaged with the motor-side gear and to which a torque generated by the motor is propagated, and a valve-side gear engaged with the intermediate deceleration gear and to which the torque is propagated; and
the motor-side gear, the intermediate deceleration gear, and the valve-side gear are inclined according to the direction of the inlet pipe axis such that a line normal to and approximately through a respective axis of each of the motor-side gear, the intermediate deceleration gear, and the valve-side gear is approximately parallel to the inlet pipe axis.

4. A fluid control valve assembly according to claim 3 wherein:
the motor has a motor diameter greater than the gear diameter of the motor-side gear;
the intermediate deceleration gear has a gear diameter smaller than the motor diameter of the motor;
the valve-side gear has a gear diameter smaller than the gear diameter of the intermediate deceleration gear; and
the valve-side gear is arranged upstream of the motor-side gear relative to flow through the inlet pipe, and the intermediate deceleration gear is arranged between the valve-side gear and the motor-side gear.

5. A fluid control valve assembly according to claim 4 wherein:
the housing has an internal fluid-introducing duct that is curved, the internal fluid-introducing duct for fluidly coupling the inlet pipe to the valve port; and
at least one of the housing and the motor has a heat transfer section, which is exposed to the fluid in the fluid-introducing duct so as to transfer heat to the fluid in the fluid-introducing duct.

6. A fluid control valve assembly according to claim 5 wherein:
the housing has a duct wall face provided against the direction of flow of the fluid entering the fluid-introducing duct;
the duct wall face is the heat transfer section; and
the valve shaft is located between the inlet pipe and the duct wall face.

7. A fluid control valve assembly according to claim 6, further comprising a check valve for reducing backflow of the fluid from an outlet port toward the valve.

8. A fluid control valve assembly according to claim 7 wherein:
the check valve has a fluid-passing opening, and wherein the fluid flows through the valve port when the check valve is in an open state; and
an axis of the fluid-passing opening is offset with respect to the valve axis such that axis of the fluid-passing opening is located on a side of the valve axis opposite to that of the inlet pipe.

9. A fluid control valve assembly according to claim 8 wherein the check valve has a movable member with a free-end and a fixed-end, wherein the free-end of the movable member elastically deforms about the fixed-end to move toward and away from the fluid-passing opening to thereby close and open the fluid-passing opening.

10. A fluid control valve assembly according to claim 9 wherein the free-end of the movable member is located on a side of the valve axis opposite to that of the inlet pipe.

11. A fluid control valve assembly according to claim 9 wherein:
the housing defines an outlet port through which the fluid exits the housing; and
the outlet port is offset with respect to the fluid-passing opening such that the axis of the fluid-passing opening is disposed between the free-end side of the movable member and the outlet port.

12. A fluid control valve assembly according to claim 11 wherein:
the housing defines a space that fluidly couples the fluid-passing opening and the outlet port;
the housing includes a duct wall face formed against the direction of flow of the fluid, wherein the duct wall face is curved.
